(19) United States
(12) Patent Application Publication
(10) Pub. No.: US 2008/0151066 A1
(43) Pub. Date: Jun. 26, 2008

(54) Imaging apparatus

(76) Inventor: Yoshio Serikawa, Kasukabe-shi (JP)

Correspondence Address: DICKSTEIN SHAPIRO LLP, 1825 EYE STREET NW, Washington, DC, 20006-5403, US

(21) Appl. No.: 11/984,957

(22) Filed: Nov. 26, 2007

(30) Foreign Application Priority Data
Dec. 12, 2006 (JP) 2006-334001

(51) Int. Cl. H04N 5/228; G03B 17/00

(52) U.S. Cl. 348/208.6; 396/55; 348/E05.031

(57) ABSTRACT

The imaging apparatus according to the present invention includes a blur detection section detecting image blurs, a high-pass filter connected to the blur detection section, a potential difference detection section detecting a potential difference between both ends of a passive circuit element constituting the high-pass filter, a reference voltage adjusting section adjusting a reference voltage applied to the high-pass filter so that the potential difference detected by the potential difference detection section falls within a preset allowable range, and a blur correction section correcting a blur detected by the blur detection section. With this configuration, it is possible to detect the potential difference of the high-pass filter in real time and correct a blur output while directly monitoring the potential difference.

### CROSS REFERENCE TO RELATED APPLICATION

The present application is based on and claims priority from Japanese Patent Application No. 2006-334001, filed on Dec. 12, 2006, the disclosure of which is hereby incorporated by reference herein in its entirety.

### BACKGROUND OF THE INVENTION

1. Field of the Invention

The present invention relates to an improvement and a modification to an imaging apparatus including a correction section correcting a blur in an image.

2. Description of Related Art

There has been a known imaging apparatus such as a camera including, for example, a gyro-sensor as blur detection means detecting a blur of a camera body. The gyro-sensor is connected with a high-pass filter which is constituted of for example, a resistor and a condenser whose one end is connected with an output terminal of the gyro-sensor and whose other end is applied with a reference voltage. The high-pass filter functions to removes DC components as a fluctuation of output voltage of the gyro-sensor, and the blur detection means outputs a blur signal (AC components due to a blur) with the DC components removed.

In order to correct an image blur, first, a difference (potential difference) between an output voltage of the output terminal of the gyro-sensor and a reference voltage is divided by a blur output sensitivity (an output mV/deg/sec relative to a rotational angle of the camera body when it rotates once per second), to obtain an angular velocity. The angular velocity is then integrated to obtain an amount of movement of the camera body. Thus, image blur is corrected by moving, for example, a CCD by blur correction means in accordance with the amount of movement of the camera body.

However, the high-pass filter has a drawback that at power-on of the imaging apparatus, it needs to be electrically charged by an amount of the potential difference thereof. This causes a response lag thereof. Moreover, the blur correction cannot be performed immediately after the power-on. Particularly, with use of a high-pass filter having a large time constant and being detectable of even low frequency components, the problem becomes more conspicuous since it takes much time to charge the condenser.

There is a known imaging apparatus incorporating a high-speed charge circuit which changes the time constant of the high-pass filter, in order to solve the response lag at the power-on and realize high-speed startup as well as to prevent electric overcharge. However, even with use of this high-speed charge circuit, there is another problem that the high-speed charge circuit operates in accordance with the output of the high-pass filter which is a target value of blur correction; therefore, the reference voltage of the high-pass filter cannot be set. In view of eliminating the cause of the response lag, Japanese Laid-Open Patent Application Publication No. 2006-214799 has proposed a technique to shorten a start-up time by adjusting the reference voltage such that the potential difference of the high-pass filter is to be zero.

However, the technique disclosed in the above document is to perform analog/digital (A/D) conversion to the input voltage and output voltage of the high-pass filter individually to find a correction value by averaging operation. This is problematic because the A/D conversion is time-consuming and accurate data cannot be acquired. Moreover, it is very difficult to find correction values when the camera body shakes or moves.

### SUMMARY OF THE INVENTION

The present invention has been made in view of solving the above problems. The object of the present invention is to provide an imaging apparatus which is able to detect the potential difference of the high-pass filter in real time and to correct the blur output while directly monitoring the potential difference.

According to one aspect of the present invention, an imaging apparatus includes a blur detection section which detects a blur in an image; a high-pass filter which is connected with the blur detection section; a potential difference detection section which detects a potential difference between both ends of a passive circuit element constituting the high-pass filter; a reference voltage adjusting section which adjusts a reference voltage applied to the high-pass filter so that the potential difference detected by the potential difference detection section is to be in a preset allowable range; and a blur correction section which corrects the blur detected by the blur detection section.

According to another aspect of the present invention, an imaging apparatus includes a blur detection section which detects a blur in an image; a high-pass filter which is connected with the blur detection section; a potential difference detection section which detects a potential difference between both ends of a passive circuit element constituting the high-pass filter; a reference voltage correcting section which corrects a reference voltage applied to the high-pass filter by arithmetic operation in accordance with the potential difference detected by the potential difference detection section; and a blur correction section which corrects the blur detected by the blur detection section according to a result of the correction by the reference voltage correcting section.

In the imaging apparatus according to the present invention, it is preferable that the passive circuit element is a condenser and includes a high-speed charge circuit which electrically charge the condenser at a high speed and that when the potential difference between both ends of the condenser falls outside the preset allowable range, the high-speed charge circuit is driven to charge the condenser at a high speed.

In the imaging apparatus according to the present invention, preferably, the reference voltage is adjusted while the condenser is charged at a high speed.

Preferably, the imaging apparatus according to the present invention further includes a temperature detection section which detects an internal temperature of a camera body, in which the preset allowable range is changed according to internal temperature information of the temperature detection section.

In the imaging apparatuses according to the present invention, it is preferable that a blur output detected by the blur detection section is corrected according to the potential difference between both ends of the high-pass filter and to a predetermined value.

Preferably, the imaging apparatus according to the present invention further include an amplifier circuit which amplifies the blur output detected by the blur detection section, in which the potential difference detection section includes an amplifier and the predetermined value is determined by a gain of the amplifier and a gain of the amplifier circuit.

In the imaging apparatus according to the present invention, the potential difference detection section is preferably constituted of a differential amplifier circuit.

In the imaging apparatus according to the present invention, it is preferable that the reference voltage correcting section stores the potential difference detected by the potential difference detection section at a predetermined timing, and corrects an amount of fluctuation of the blur output according to the detected potential difference.

According to the present invention, it is made possible to detect the potential difference of the high-pass filter as well as to correct the blur output while monitoring the potential difference directly. Accordingly, it is made possible to improve the response characteristics and blur correction accuracy of the imaging apparatus.

### BRIEF DESCRIPTION OF THE DRAWINGS

FIG. 1 shows a front view of a digital camera according to the present invention;

FIG. 2 shows a back view of a digital camera according to the present invention;

FIG. 3 shows a top view of a digital camera according to the present invention;

FIGS. 4A to 4D show a block circuit diagram of a digital camera according to the present invention;

FIG. 5 is a block circuit diagram showing an example of the blur detection section shown in FIG. 4B;

FIG. 6 is a circuit diagram showing detailed configurations of the gyro-sensor, high-pass filter, potential difference detection circuit, and amplifier circuit shown in FIG. 5;

FIG. 7 is a flowchart describing reference voltage adjusting steps of the processor shown in FIG. 4C;

FIG. 8A shows a graph for describing a fluctuation of the potential difference of the high-pass filter shown in FIG. 6 relative to a reference voltage adjusting section;

FIG. 8B shows a graph for describing a fluctuation of the potential difference of the high-pass filter shown in FIG. 6 relative to a high-speed charge operation;

FIG. 9 is a graph describing the time taken for the potential difference of the high-pass filter shown in FIG. 6 to be in a stable state;

FIG. 10 is a flowchart describing operational steps of the high-speed charge circuit shown in FIG. 6;

FIG. 11 is a block circuit diagram showing another example of the blur detection section shown in FIG. 4B;

FIG. 12 a circuit diagram showing detailed configurations of the gyro-sensor, high-pass filter, potential difference detection circuit, and amplifier circuit shown in FIG. 11;

FIG. 13 is a flowchart describing arithmetic operation of a reference voltage by the processor shown in FIG. 11; and

FIG. 14 is a flowchart describing operational steps of the high-speed charge circuit shown in FIG. 11.

### DESCRIPTION OF THE PREFERRED EMBODIMENT

Hereinafter, a digital camera will be described as an example of the imaging apparatus according to the present invention, with reference to the accompanying drawings.

### (General Configuration of Digital Camera)

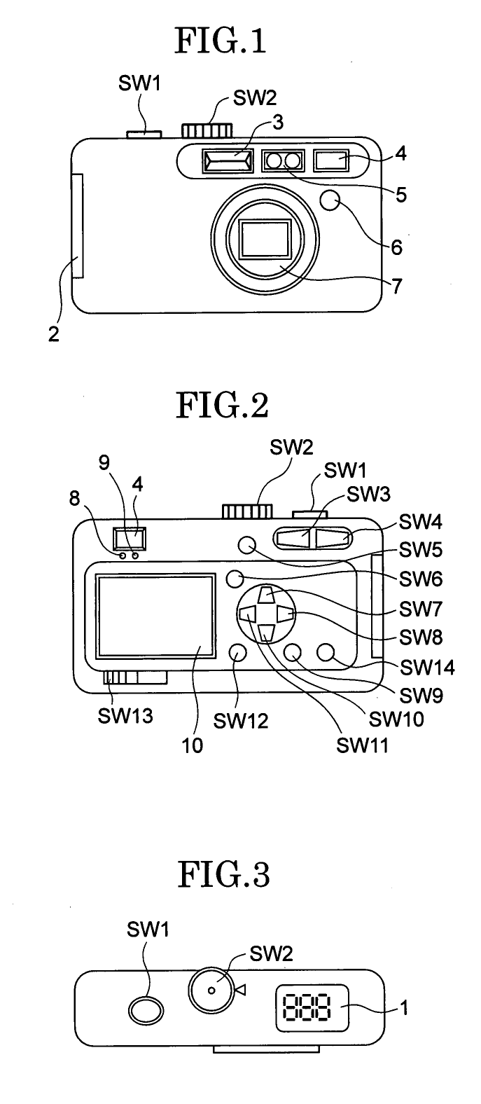

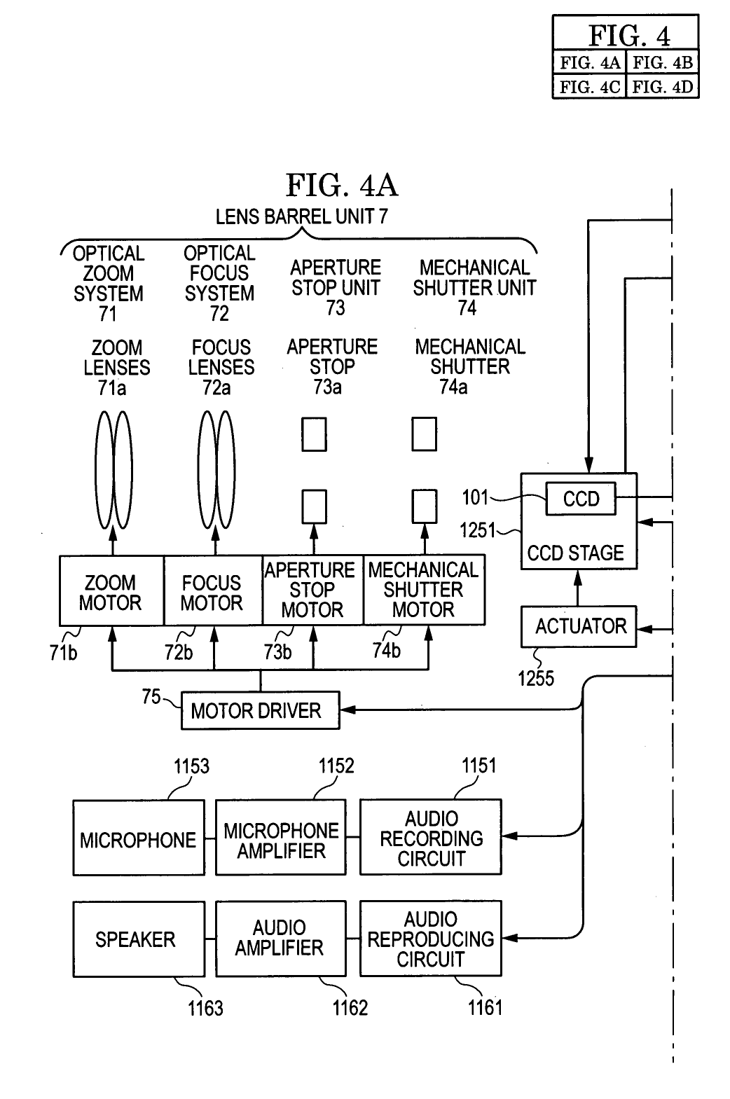

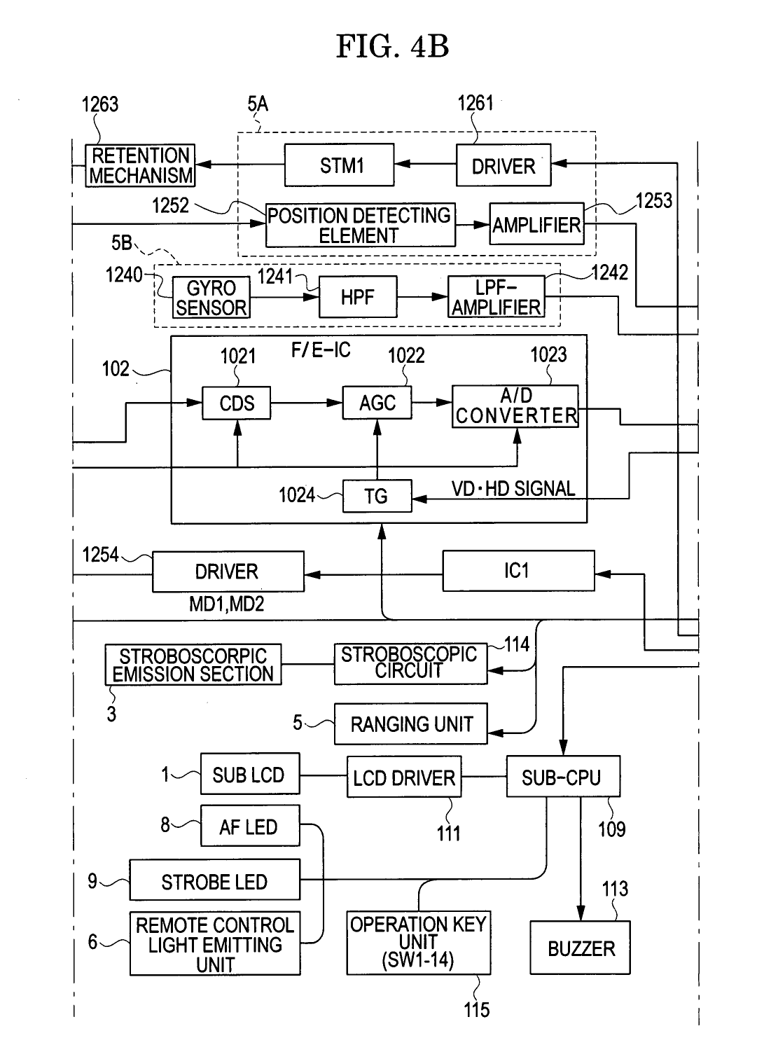

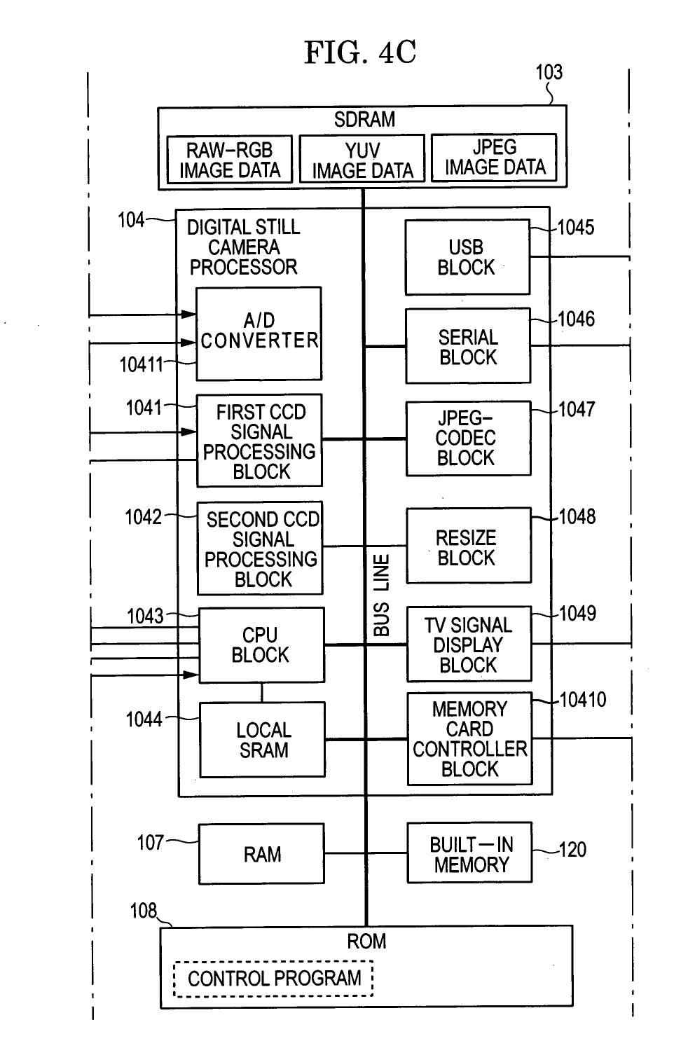

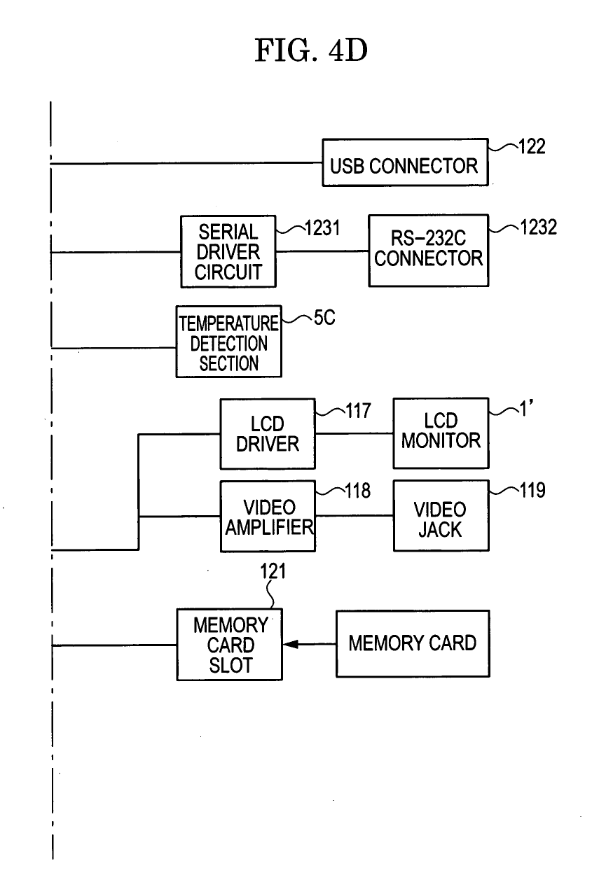

FIG. 1 is a front view of a digital camera as one example of the imaging apparatus according to the present invention, FIG. 2 is back view thereof, FIG. 3 is a top view thereof and FIGS. 4A to 4D are a circuit block diagram showing schematic system configuration of the inside of the digital camera.

In FIG. 1, a release switch (release shutter) SW1, a mode dial SW2, and a sub liquid crystal display (sub LCD) shown in FIG. 3 are disposed on a top plane (when a plane facing a subject is a front) of a camera body.

On the front plane (subject side) of the camera body, provided are a lens barrel unit 7 including a photographic lens, an optical finder 4, a stroboscopic emission section 3, a ranging unit 5, and a remote-control light receiving section 6.

As shown in FIG. 2, on the back plane (photographer side) of the camera body, provided are a power-on switch SW13, an LCD monitor 10, an auto focus LED 8, a stroboscopic LED 9, an optical finder 4, a wide angle direction zoom switch SW3, a telephoto direction zoom switch SW4, a self timer setting/releasing switch SW5, a menu switch SW6, an upward movement/stroboscopic setting switch, a rightward movement switch SW8, a display switch SW9, a downward movement/micro switch SW10, a leftward movement/image checkup switch SW11, an OK switch SW12, and a blur correction switch SW14. A lid 2 is provided for a memory card/battery loading room on a back plane of the camera body.

Next, the system configuration of the inside of the camera will be described. In FIG. 4C, the number 104 denotes a digital still camera processor (hereinafter, referred to as a processor).

The processor 104 includes an A/D converter 10411, a first CCD signal processing block 1041, a second CCD signal processing block 1042, a CPU block 1043, a local SRAM 1044, an USB block 1045, a serial block 1046, a JPEG/CODEC block (for JEPG compression/decompression) 1047, a RESIZE block (for size expansion and reduction of image data by an interpolation processing) 1048, a TV signal display block (for image data conversion to a video signal for display on a display device such as a liquid crystal monitor or a TV) 1049, and a memory card controller block (for control of a memory card for recording captured image data) 10410. These blocks are connected to each other via a bus line.

In the outside of the processor 104, disposed is an SDRAM 103 for storing therein RAW-RGB image data (with white balance setting and gamma setting made), YUV image data (with luminance data and color difference data conversion performed), and JPEG image data (compressed by JPEG). The SDRAM 103 is connected to the processor 104 via a memory controller (not shown) and a bus line.

In the outside of the processor 104, further disposed are a RAM 107, a built-in memory 120 (for storage of captured image data without a memory card installed in a memory card slot), and a ROM 108 having a control program, a parameter, etc., stored therein. These are connected to the processor 104 via a bus line.

Upon turning on of the power-on switch SW13 of the camera, the control program stored in the ROM 108 is loaded in the main memory (not shown) of the processor 104. The processor 104 controls the operation of the respective sections according to the control program and also temporarily stores control data, parameters, etc., in the RAM 107 or the like.

The lens barrel unit 7 includes a lens barrel constituted of an optical zoom system 71 having zoom lenses 71a as a lens system, an optical focus system 72 having focus lenses 72a as a lens system, an aperture stop unit 73 having an aperture stop 73a, and a mechanical shutter unit 74 having a mechanical shutter 74a.

The zoom optical system 71, optical focus system 72, aperture stop unit 73, and mechanical shutter unit 74 are driven by a zoom motor 71b, a focus motor 72b, an aperture stop motor 73b, and a mechanical shutter motor 74b, respectively.

Each of these motors is driven by a motor driver 75, and the motor driver 75 is controlled by the CPU block 1043 of the processor 104.

A subject image is formed on the CCD 101 by each of the lens systems of the lens barrel unit 7, and the CCD 101 converts the subject image into an image signal to output the image signal to an F/E-IC 102. The F/E-IC 102 includes a CDS 1021 which performs correlated double sampling for eliminating noise from the image, an AGC 1022 for gain adjustment, and an A/D converter 1023 for analog/digital conversion. More particularly, F/E-IC 102 conducts a predetermined processing to the image signal to convert the analog image signal to the digital signal, and output the digital signal to the first CCD signal processing block 1041 of the processor 104.

These signal control processings are performed via a TG 1024 by a vertical synchronization signal VD and a horizontal synchronization signal HD output from the first CCD signal processing block 1041 of the processor 104. The TG 1024 generates a driving timing signal according to the vertical synchronization signal VD and the horizontal synchronization signal HD.

The CPU block 1043 of the processor 104 is configured to control audio recording operation of an audio recording circuit 1151. Audio is converted to an audio recording signal with a microphone 1153. The audio recording circuit 1151 records, according to a command, a signal which is obtained by amplifying the audio recording signal by a microphone amplifier 1152. The CPU block 1043 controls operation of an audio reproducing circuit 1161 which is configured to reproduce an audio signal stored in a memory appropriately according to a command and outputs the reproduced signal to an audio amplifier 1162 so as to output sound from a speaker 1163.

The CPU block 1043 controls a stroboscopic circuit 114 so as to emit illumination light from the stroboscopic light emitting section 3. The CPU block 1043 also controls the ranging unit 5.

The CPU block 1043 is connected to a sub CPU 109 of the processor 104. The sub CPU 109 controls display on the sub LCD 1 via an LCD driver 111. The sub CPU 109 is also connected to the AFLED 8, stroboscopic LED 9, remote control light receiving section 6, an operation key unit having the operation switches SW1-SW14 and a buzzer 113.

The USB block 1045 is connected to a USB connector 122. The serial block 1046 is connected to an RS-232C connector 1232 via a serial driving circuit 1231. The TV signal display block 1049 is connected to the LCD monitor 10 through an LCD driver 117 and to a video jack (for connecting the camera to an external display device such as a TV) 119 via a video amplifier 118 (for conversion of a video signal output from the TV signal display block 1049 into 75Ω impedance). The memory card controller block 10410 is connected to a contact point with the card contact point of a memory card slot 121.

The LCD driver 117 drives the LCD monitor 10 and also converts the video signal output from the TV signal display block 1049 into a signal for display on the LCD monitor 10. The LCD monitor 10 is used for monitoring condition of a subject before photographing, checking captured images and displaying image data recorded in the memory card or the built-in memory 120.

The body of the digital camera is provided with a fixation casing (not shown) constituting a part of the lens barrel unit 7. The fixation casing is provided with a CCD stage 1251 movable in the X-Y direction. The CCD 101 is installed in the CCD stage 1251 constituting a part of a blur correction section 5A. A description of detailed mechanical structure of the CCD stage 1251 will be omitted.

The CCD stage 1251 is driven by an actuator 1255, and the driving of the actuator 1265 is controlled by a driver 1254 which includes a first coil drive MD1 and a second coil drive MD2. The driver 1254 is connected to an analog/digital converter IC1 which is connected to the CPU block 1043. Control data is input to the analog/digital converter IC1 from the CPU block 1043.

The fixation casing is provided with a reference position forced retention mechanism 1263 which retains the CCD stage 1251 in a central position when the blur correction switch SW14 is powered off and the power-on switch SW13 is powered off. The reference position forced retention mechanism 1263 is controlled by a stepping motor STM1 as an actuator which is driven by a driver 1261. Control data is input to the driver 1261 from the ROM 108.

The CCD stage 1251 is provided with a position detecting element 1252. The detection output of the position detecting element 1252 is input to an operational amplifier 1253 and amplified therein, and the amplified detection output is input to the A/D converter 10411. The camera body is provided with a gyro-sensor 1240 which constitutes a part of a blur detection section 5B and can detect the rotation of the camera in the pitch direction and yaw direction. After passing through a high pass filter 1241, the detection output of the gyro-sensor 1240 is input to the A/D converter 10411 via an amplifier 1242 which is also used as a low pass filter.

Next, general operation of the camera according to the present invention will be schematically described.

The camera is activated in a photographing mode, upon a press to the power-on switch SW13 while the mode dial SW2 is set in the photographing mode. Also, upon a press to the power-on switch SW13 while the mode dial SW2 is set in a reproducing mode, the camera is activated in the reproducing mode. The processor 104 determines which of the photographing mode and the reproducing mode the switch of the mode dial SW2 is in.

The processor 104 controls the motor driver 75 to move the lens barrel of the lens barrel unit 7 to a photographable position. Moreover, the processor 104 turns on the respective circuits of the CCD 101, F/E-IC 102, LCD monitor 10 and the like to start their operation. Upon the power-on of the respective circuits, the operation is initiated in a finder mode.

In the finder mode, light incident into the image pick-up device (CCD 101) through each of the lens systems is photo-electrically converted and transmitted to the CDS circuit 1021 and the A/D converter 1023 as RGB analog signals. The A/D converter 1023 converts the analog signals into digital signals. The digital signals are converted into YUV image data by a YUV converter in the digital signal processing IC (SDRAM 103), and written into a frame memory by a memory controller (not shown).

The YUV signal is read by the memory controller, and is transmitted to a TV (not shown) or the LCD monitor 10 via the TV signal display block 1049 for display of a captured image. This processing is performed at intervals of 1/30 second; thus, the display of the captured image is renewed in the finder mode at every 1/30 second. Namely, a monitoring processing is carried out. Then, the processor 104 determines whether or not the setting of the mode dial SW2 has been changed. With no change in the setting of the mode dial SW2, photographing processing is carried out according to a manipulation to the release switch SW1.

In the reproducing mode, the processor 104 allows the LCD monitor 10 to display the captured image. Then, the processor 104 determines whether or not the setting of mode dial SW2 has been changed. With a change in the setting of mode dial SW2, the processing goes back to the initial processing.

Since the configurations of the above circuits are well known, detailed description thereon will be omitted. Hereinafter, a description will be made on a relationship among a blur detection section 5B which is a characterizing portion of the present invention, a temperature detection section 5C, and the processor 104.

### First Embodiment

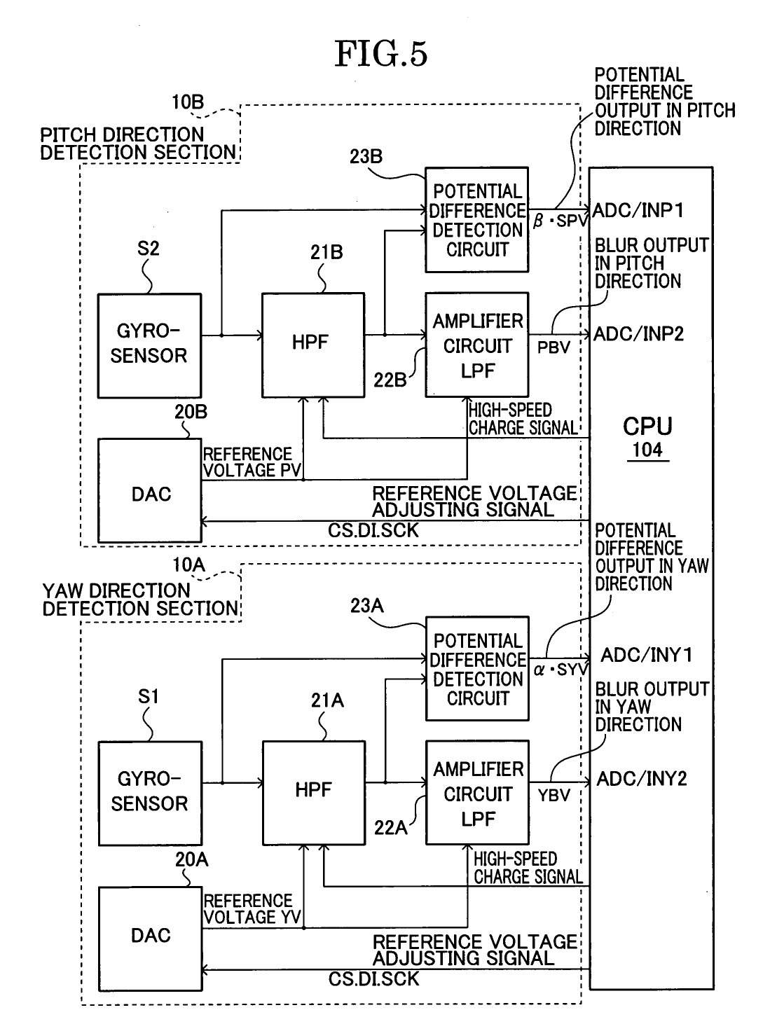

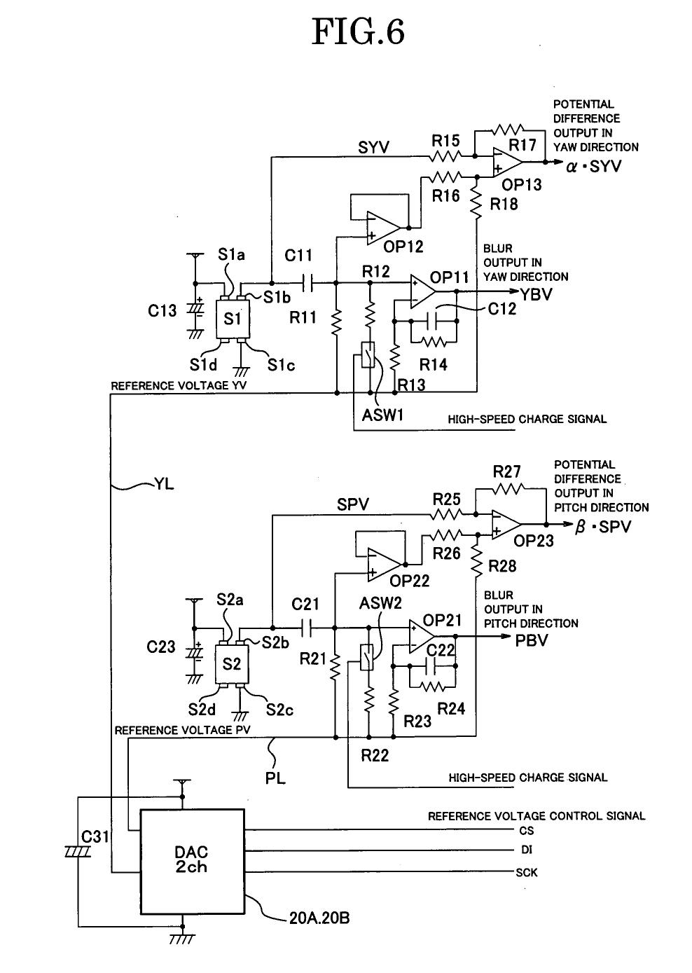

As shown in FIGS. 5 and 6, the blur detection section 5B is composed of a yaw direction detection section 10A for detection in a yaw direction and a pitch direction detection section 10B for detection in a pitch direction.

The yaw direction detection section 10A includes a gyro-sensor S1 as a blur detection section for detection in the yaw direction, a digital/analog converter (DAC) 20A constituting a part of the reference voltage adjusting section, a high-pass filter (HPF) 21A, an amplifier circuit (LPF) 22A and a potential difference detection circuit (potential difference detection section) 23A.

The pitch direction detection section 10B includes a gyro-sensor S2 as a blur detection section for detection in the pitch direction, a digital/analog converter (DAC) 20B constituting a part of the reference voltage adjusting section, a high-pass filter (HPF) 21B, an amplifier circuit (LPF) 22B and a potential difference detection circuit (potential difference detection section) 23B.

Here, the digital/analog converters (DAC) 20A and 20B each are composed of a single circuit element with two channels to which a serial clock signal SCK, a chip select signal CS, and channel select signal/DA conversion data DI are input from the processor 104.

A pitch direction reference voltage signal line PL and a yaw direction reference voltage signal line YL extend from the digital/analog converter (DAC) 20A. The yaw direction reference voltage signal line YL is used for supplying a yaw direction reference voltage YV to the high-pass filter (HPF) 21A, and the pitch direction reference voltage signal line PL is used for supplying a pitch direction reference voltage PV to the high-pass filter (HPF) 21B. Note that the reference voltages YV and PV are voltages when a blur signal is not output from an output terminal (to be described later) of the gyro-sensor, and defined for a design purpose.

The yaw direction reference voltage is adjusted and the pitch direction reference voltage PV is set according to the chip select signal CS, channel select signal/DA conversion data DI. The digital/analog converters 20A and 20B are connected with a condenser C31 for power supply. The condenser C31 is applied with a predetermined voltage at its positive side and grounded at its negative side.

A first terminal S1a of the gyro-sensor S1 is connected to the positive side of a condenser C13 for power supply, and the negative side of the condenser 13 is grounded. An electrode of the positive side of the condenser C13 is applied with a predetermined voltage.

The high-pass filter (HPF) 21A includes a condenser as a passive circuit element, resistors R11 and R12, and a selector switch ASW1. The second terminal (output terminal) S1b of the gyro-sensor S1 is connected to one side of the condenser C11. The third terminal S1c of the gyro-sensor S1 is grounded, and the fourth terminal S1d thereof is open.

The other side of the condenser C11 is connected to one side of the resistor R11 and one side of the resistor R12. The other side of the resistor R11 is connected to the yaw direction reference voltage signal line YL. The other side of the resistor R12 is connected to the yaw direction reference voltage signal line YL via the selector switch ASW1 to which a high-speed charge signal is input from the processor 104.

Here, the condenser C11 and the resistor R11 constitute a high-pass filter, and the resistor R12 and the selector switch ASW1 constitute a high-speed charge circuit. The resistor R11 is set to have a larger value than the resistor R12. When the selector switch ASW1 is turned on by the high-speed charge signal from the processor 104, the condenser C11 is electrically charged at high speed via the resistor R12.

The amplifier circuit (LPF) 22A includes an operational amplifier OP11, a condenser C12, a resistor R14, and a resistor R13. The output signal of the gyro-sensor S1 is input to the positive terminal of the operational amplifier OP11 via the condenser C11. The negative terminal of the operational amplifier OP11 is connected to the yaw direction reference voltage signal line YL via the resistor R13, and the output terminal thereof is connected to one side of the condenser C12. The other side of the condenser C12 is connected to the negative side of the operational amplifier OP11. The condenser C12 and the resistor R14 constitute a low-pass filter.

The high-pass filter (HPF) 21A removes direct-current components of the output signal of the gyro-sensor S1 in order to prevent a shake of an image while the amplifier circuit (LPF) 22A removes noise signals with the low-pass filter and amplifies output signals to output a blur output in the yaw direction to an ADC/INY2 terminal of the processor 104 in order to improve image quality.

The potential difference detection circuit 23A is composed of operational amplifiers OP12 and OP13 and resistors R15, R16, and R17. The positive terminal of the operational amplifier OP12 is connected to the other side of the condenser C11, the positive terminal of the operational amplifier OP11, one side of the resistor R11, and one side of the resistor R12. The high-pass filter has high impedance at its output so that the operational amplifier OP 12 functions as a buffer circuit for impedance conversion.

The output terminal of the operational amplifier OP12 is connected to the positive terminal of the operational amplifier OP13 via the resistor R16, and connected to the negative side of the operational amplifier OP 12. The negative terminal of the operational amplifier OP13 is connected to the second terminal S1b of the gyro-sensor S1 via the resistor R15. The output terminal of the operational amplifier OP13 is connected to the negative terminal of the operational amplifier OP13 via the resistor R17. A resistor 18 is connected to the positive terminal of the operational amplifier OP 13 at one side, and connected to the yaw direction reference voltage signal line YL at the other side. A potential difference in the yaw direction is output from the output terminal of the operational amplifier OP13 to the ADC/INY1 terminal of the processor 104.

The resistors R15 and R16 are set to have the same resistance value, and the resistors R17 and R18 are set to have the same resistance value. A potential difference of the high-pass filter from the reference voltage YV is detected at the input terminal of the operational amplifier OP13. From the output terminal of the operational amplifier OP13, output is an output α·SYV of a potential difference in the yaw direction which has been amplified (α=resistance value of resistor 17/resistance value of resistor 15) times.

Accordingly, it is made possible to find a fluctuation amount of a blur output in the yaw direction YBV due to the potential difference SYV of the high-pass filter by setting a certain relation between a gain of the amplifier circuit (LPF) 22A determined from the resistors 13 and 14 thereof and a gain determined from the resistors 17 and 15 of the potential difference detection circuit 23A, which enables the correction of an error in the blur output in the yaw direction YBV due to erroneous electric charge.

Note that the correction value of the blur output in the yaw direction YBV is obtained by the following expression:

Correction value=(potential difference SYV*K)−reference voltage YV (1)

where K is a proportionality coefficient when it is assumed that a certain proportional relation is to be established between the gain of the amplifier circuit (LPF) 22A and the gain of the potential difference detection circuit 23A.

Moreover, the first terminal S2a of the gyro-sensor S2 is connected to the positive side of a condenser C23 for power supply, and the negative side of the condenser 23 is grounded. An electrode of the positive side of the condenser C23 is applied with a predetermined voltage.

The high-pass filter (HPF) 21B includes a condenser C21, resistors R21 and R22, and a selector switch ASW2. The second terminal (output terminal) S2b of the gyro-sensor S2 is connected to one side of the condenser C21. The third terminal S2c of the gyro-sensor S2 is grounded, and the fourth terminal S2d thereof is open.

The other side of the condenser C21 is connected to one side of the resistor R21 and one side of the selector switch ASW2. The other side of the resistor R21 is connected to the pitch direction reference voltage signal line PL. The other side of the selector switch ASW2 is connected to the pitch direction reference voltage signal line PL via the resistor R22. The selector switch ASW2 is input with a high-speed charge signal from the processor 104.

Here, the condenser C21 and the resistor R21 constitute a high-pass filter, and the resistor R22 and the selector switch ASW2 constitute a high-speed charge circuit. The resistor R21 is set to have a larger value than the resistor R22. When the selector switch ASW2 is turned on by the high-speed charge signal from the processor 104, the condenser C21 is electrically charged at high speed via the resistor R22.

The amplifier circuit (LPF) 22B includes an operational amplifier OP21, a condenser C22, a resistor R23, and a resistor R24. The output signal of the gyro-sensor S2 is input to the positive terminal of the operational amplifier OP21 via the condenser C21. The negative terminal of the operational amplifier OP21 is connected to the pitch direction reference voltage signal line PL via the resistor R23, and the output terminal thereof is connected to one side of the condenser C22. The other side of the condenser C22 is connected to the negative terminal of the operational amplifier OP21. The condenser C22 and the resistor R24 constitute a low-pass filter.

The high-pass filter (HPF) 21B removes direct-current components of the output signal of the gyro-sensor S2 in order to prevent a shake of an image while the amplifier circuit (LPF) 22B removes noise signals with the low-pass filter and amplifies output signals to output a blur output in the pitch direction to an ADC/INP2 terminal of the processor 104 in order to improve image quality.

The potential difference detection circuit 23B is composed of operational amplifiers OP22 and OP23 and resistors R25, R26, and R27. The positive terminal of the operational amplifier OP22 is connected to the other side of the condenser C21, the positive terminal of the operational amplifier OP21, one side of the resistor R21, and one side of the resistor R22. The high-pass filter has high impedance at its output so that the operational amplifier OP 22 functions as a buffer circuit for impedance conversion.

The output terminal of the operational amplifier OP22 is connected to the positive terminal of the operational amplifier OP23 via the resistor R26. The negative terminal of the operational amplifier OP23 is connected to the second terminal S2b of the gyro-sensor S2 via the resistor R25. The output terminal of the operational amplifier OP23 is connected to the negative terminal of the operational amplifier OP23 via the resistor R27. A resistor 28 is connected to the positive terminal of the operational amplifier OP 23 at one side, and connected to the pitch direction reference voltage signal line PL at the other side. A potential difference in the pitch direction is output from the output terminal of the operational amplifier OP23 to the ADC/INP1 terminal of the processor 104.

The resistors R25 and R26 are set to have the same resistance value, and the resistors R27 and R28 are set to have the same resistance value. A potential difference SPV of the high-pass filter from the reference voltage PV is detected at the input terminal of the operational amplifier OP23. From the output terminal of the operational amplifier OP23, output is a potential difference output in the pitch direction β·SPV which has been amplified (β=resistance value of resistor 27/resistance value of resistor 25) times.

Accordingly, it is made possible to find a fluctuation amount of a blur output in the pitch direction PBV due to the potential difference SPV of the high-pass filter by setting a certain relation between a gain of the amplifier circuit (LPF) 22B determined from the resistors 23 and 24 thereof and a gain determined from the resistors 27 and 25 of the potential difference detection circuit 23B, which enables the correction of an error in the blur output in the pitch direction PBV due to erroneous electric charge.

Note that the correction value of the blur output in the pitch direction PBV is obtained by the following expression:

Correction value=(potential difference SPV*K)−reference voltage PV (2)

where K is a proportionality coefficient when it is assumed that a certain proportional relation is to be established between the gain of the amplifier circuit (LPF) 22B and the gain of the potential difference detection circuit 23B.

The processor 104 changes the reference voltages YV, PV of the digital analog converters (DAC) 20A, 20B so that the potential difference in the yaw direction SYV of the high-pass filter and the potential difference in the pitch direction SPV thereof are to be equal to or less than a predetermined allowable value for the potential difference.

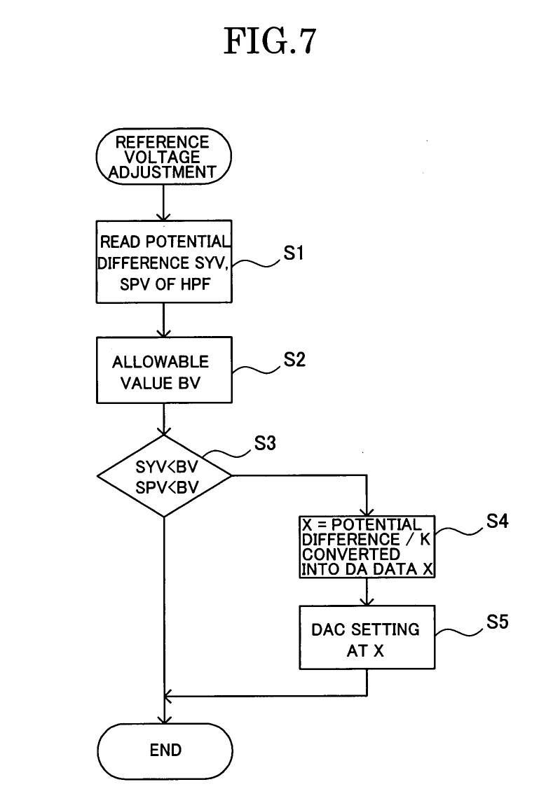

As shown in the flowchart of FIG. 7, the processor 104, when set in a reference voltage adjustment mode according to manipulation to the release switch SW1, allows the potential difference detection circuits 23A, 23B to read the potential differences SYV, SPV of the high-pass filters 21A, 21B (S1). Then, the processor 104 reads the allowable value BV of the potential differences SYV, SPV which are determined in advance depending on the characteristics of the gyro-sensors S1, S2 (S2). Thereafter, the processor 104 determines whether the potential differences SYV, SPV are larger/smaller than the allowable value BV (S3).

When the potential differences SYV, SPV are smaller than the allowable value BV, the processor 104 maintains the reference voltages YV, PV obtained in the previous processing. On the other hand, with the potential differences SYV, SPV being larger than the allowable value BV, it finds digital-analog conversion data X by the following expression (S4):

X=potential difference/K value, where the K value is a voltage conversion coefficient for 1-bit of the AD converter (ADC) and 1-bit of DA converter (DAC).

Then, the processor 104 outputs the DA conversion data X to the DA converters (DAC) 20A, 20B (S5), to adjust the reference voltages YV, PV thereof. Thus, the processor 104 also functions as a reference voltage adjusting section.

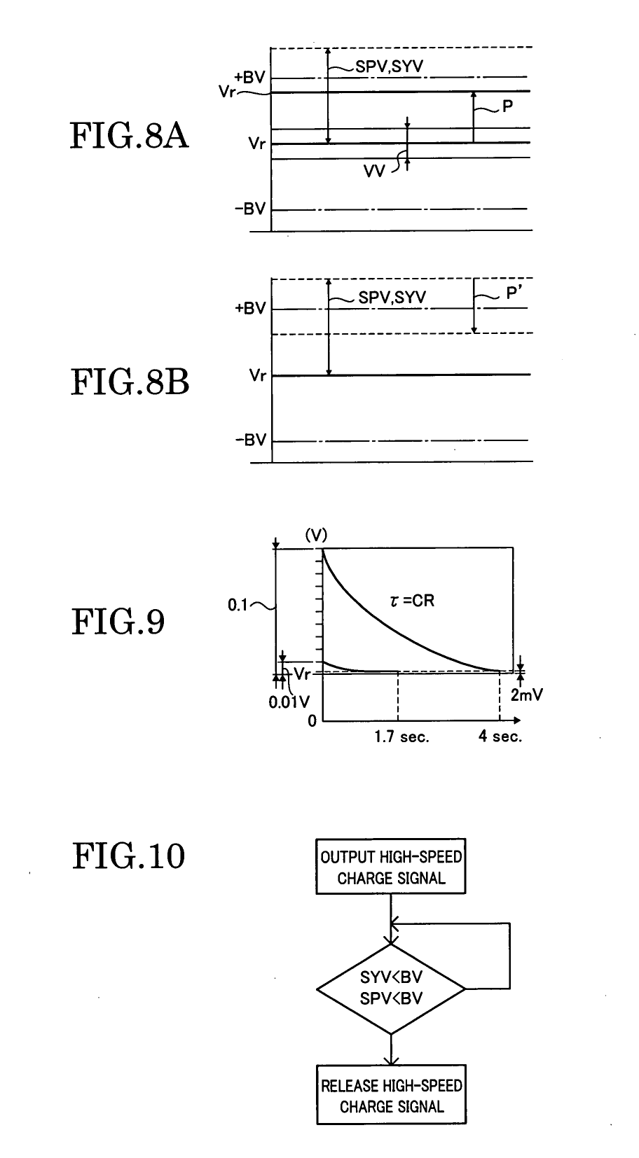

The second terminals S1b, S2b of the gyro-sensors S1, S2 have a predetermined potential difference from the other sides of the condensers C11, C21, and there is a drift therebetween in addition to the potential difference, which is shown in the graph of FIG. 8A. The gyro-sensors S1, S2 have a fluctuation DV in the potential difference due to a drift in addition to a fluctuation VV in the potential difference due to their individual differences. Allowable values BV (upper and lower limits of allowable range) are determined with the fluctuations taken into consideration, and a center value of the allowable values are set to be a reference voltage Vr (to be used as a general term for PV and YV). Therefore, when the absolute values of the potential differences SYV, SPV are larger than the absolute values of the allowable values BV, the reference voltage Vr is adjusted in a direction of the arrow P so that the potential differences SYV, SPV fall within the allowable range.

The blur correction based on the output fluctuation of the gyro-sensors S1, S2 gives a different effect depending on photographic condition. For example, when blur output sensitivity is 50 mV/deg/sec, focal distance is 100 mm, shutter speed is 1/10 second, blur output fluctuation is 100 mV (where voltage difference from the reference voltage in the high-pass filter is 2 mV, and gain of the amplifier circuits (LPF) 20A, 20B is 50), an erroneous blur will be 60 μm, which is equivalent to 30 pixels when a pixel pitch of the CCD is 2 μm.

Here, for example, in a case where the capacity of the condenser C11 of the high-pass filter is 10 μF, the resistance value of the resistor R11 is 100 KΩ, the potential difference of a stable high-pass filter is 0.1V, the allowable range of the erroneous blur is +2 mV to −2 mV when reduced to the yaw direction blur output of the amplifier circuit (LPF) 22A, it takes about 4 seconds for the erroneous blur to be equal to or lower than 2 mV, as shown in FIG. 9. However, at the potential difference of 0.01V, the time will be decreased to about 1.7 seconds. Note that ξ=C×R signifies a time constant in FIG. 9.

In view of the above, the reference voltage Vr (PV, YV) is set according to the DA conversion data X so that the potential differences SPV, SYV can be 0.01V, for example. This can improve response characteristics of the blur correction section at the turning-on of the power-on switch SW13.

The processor 104 obtains the correction values (obtained by the expressions (1), (2)) according to the blur outputs YBV, PBV, and obtains the movement amount of the CCD by the conventional expression, for example. In other words, the amount of fluctuation relative to the reference voltage Vr set by the DAC is primarily defined so that the blur correction amount is found.

A shake or motion of the camera body such as panning causes a potential difference between the second terminals S1b, S2b of the gyro-sensors S1, S2 and the other sides of the condensers C11, C21 to get larger than the allowable value BV (outside the allowable range). When this occurs, the processor 104 outputs the high-speed charge signal to the high-speed charge circuit and continues the output while the potential difference SYV, SPV are larger than the allowable value BV, and releases the high-speed charge signal when the potential differences SYV, SPV become smaller than the allowable value BV, as shown in FIG. 10. In other words, the potential difference decreases in a direction indicated by the arrow P, whereby electric overcharge to the condensers is preventable.

In this case, when it is assumed that the resistance value of the resistor R12 of the high-speed charge circuit is 1 KΩ, and the overcharge amount is 100 mV, it takes 0.04 seconds for the blur output to be less than or equal to 2 mV.

As described above, decreasing the potential difference of the high-pass filter leads to improving the responsiveness thereof. Moreover, with the occurrence of the overcharge thereto, quick electric discharge is enabled. Note that the reference voltage can be adjusted during the operation of the high-speed charge circuit.

Furthermore, a temperature change causes the fluctuation of the potential difference of the high-pass filter due to the output fluctuation of the gyro-sensor depending on the temperature characteristics thereof and the temperature characteristics of the DA converter (DAC) and the respective amplifiers (differential amplifier circuit). To prevent this from occurring, it is preferable that the camera body incorporates a temperature detection section 5C so that the processor 104 changes the allowable values BV in accordance with internal temperature information on the camera body from the temperature detection section 5C.

Note that the temperature detection section 5C can be a thermistor, a positive temperature coefficient resistor, and a temperature sensor such as a semiconductor element.

### Second Embodiment

In the second embodiment, the same components as those in the first embodiment will be given the same numbers and codes thereof.

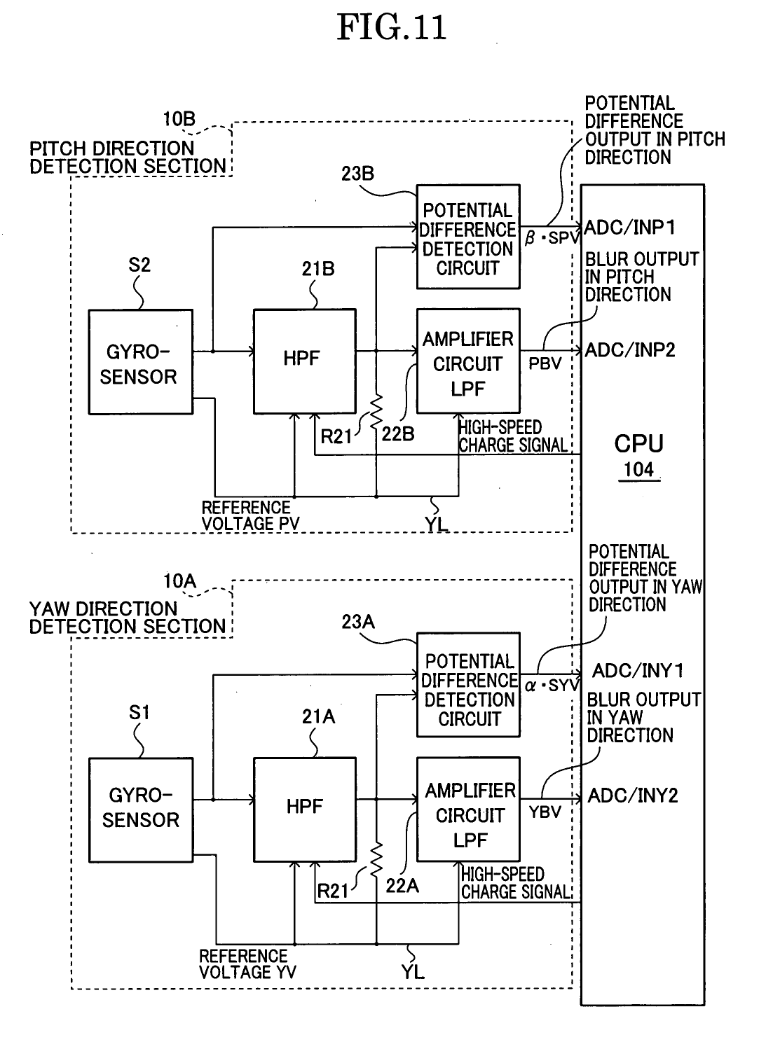

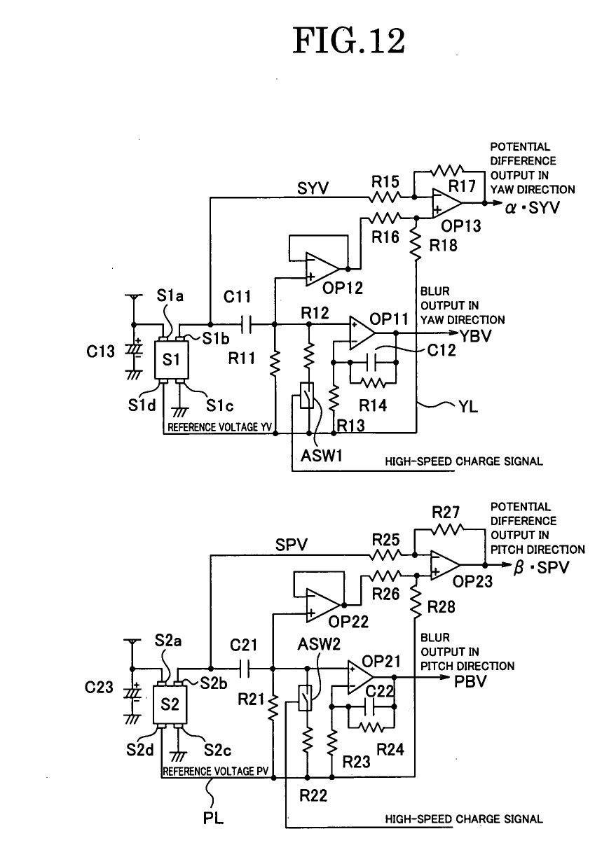

As shown in FIG. 11, the blur detection section 5B is composed of a yaw direction detection section 10A for detection in a yaw direction and a pitch direction detection section 10B for detection in a pitch direction.

The yaw direction detection section 10A includes a gyro-sensor S1 for detection in the yaw direction, a high-pass filter (HPF) 21A, an amplifier circuit (LPF) 22A and a potential difference detection circuit 23A.

The pitch direction detection section 10B includes a gyro-sensor S2 for detection in the pitch direction, a high-pass filter (HPF) 21B, an amplifier circuit (LPF) 22B and a potential difference detection circuit 23B.

The first terminal S1a of the gyro-sensor S1 is connected to the positive side of a condenser C13 for power supply, and the negative side of the condenser C13 is grounded. An electrode of the positive side thereof is applied with a predetermined voltage.

The high-pass filter (HPF) 21A includes a condenser C11, resistors R11 and R12, and a selector switch ASW1. The second terminal S1b of the gyro-sensor S1 is connected to one side of the condenser C11. The third terminal S1c of the gyro-sensor S1 is grounded, and the fourth terminal S1d thereof is used for a reference voltage supply terminal.

The other side of the condenser C11 is connected to one side of the resistor R11 and one side of the resistor R12. The other side of the resistor R11 is connected to a yaw direction reference voltage signal line YL which extends from the fourth terminal S1d. The other side of the resistor R12 is connected to the yaw direction reference voltage signal line YL via the selector switch ASW1 to which a high-speed charge signal is input from the processor 104.

Here, the condenser C11 and the resistor R11 constitute a high-pass filter, and the resistor R12 and the selector switch ASW1 constitute a high-speed charge circuit. The resistor R11 is set to have a larger value than the resistor R12. When the selector switch ASW1 is turned on by the high-speed charge signal from the processor 104, the condenser C11 is electrically charged at high speed via the resistor R12.

The amplifier circuit (LPF) 22A includes an operational amplifier OP11, a condenser C12, a resistor R13, and a resistor R14. The output signal of the gyro-sensor S1 is input to the positive terminal of the operational amplifier OP11 via the condenser C11. The negative terminal of the operational amplifier OP11 is connected to the yaw direction reference voltage signal line YL via the resistor R13, and the output terminal thereof is connected to one side of the condenser C12. The other side of the condenser C12 is connected to the negative side of the operational amplifier OP11. The condenser C12 and the resistor R14 constitute a low-pass filter.

The high-pass filter (HPF) 21A removes direct-current components of the output signal of the gyro-sensor S1 in order to prevent a shake of an image while the amplifier circuit (LPF) 22A removes noise signals with the low-pass filter and amplifies output signals to output blur signals in the yaw direction to an ADC/INY2 terminal of the processor 104 in order to improve image quality.

The potential difference detection circuit 23A is composed of operational amplifiers OP12 and OP13 and resistors R15, R16, and R17. The positive terminal of the operational amplifier OP12 is connected to the other side of the condenser C11, the positive terminal of the operational amplifier OP11, one side of the resistor R11, and one side of the resistor R12. The high-pass filter has high impedance at its output so that the operational amplifier OP 12 functions as a buffer circuit for impedance conversion.

The output terminal of the operational amplifier OP12 is connected to the positive terminal of the operational amplifier OP13 via the resistor R16, and connected to the negative side of the operational amplifier OP 12. The negative terminal of the operational amplifier OP13 is connected to the second terminal S1b of the gyro-sensor S1 via the resistor R15. The output terminal of the operational amplifier OP13 is connected to the negative terminal of the operational amplifier OP13 via the resistor R17. A resistor 18 is connected to the positive terminal of the operational amplifier OP 13 at one side, and connected to the yaw direction reference voltage signal line YL at the other side. A potential difference in the yaw direction is output from the output terminal of the operational amplifier OP13 to the ADC/INY1 terminal of the processor 104.

The resistors R15 and R16 are set to have the same resistance value, and the resistors R17 and R18 are set to have the same resistance value. A potential difference of the high-pass filter from the reference voltage YV is detected at the input terminal of the operational amplifier OP13. From the output terminal of the operational amplifier OP13, output is a potential difference output in the yaw direction α·SYV which has been amplified (α=resistance value of resistor 17/resistance value of resistor 15) times.

Accordingly, it is made possible to find a fluctuation amount of a blur output in the yaw direction YBV based on the potential difference of the high-pass filter by setting a certain relation between a gain of the amplifier circuit (LPF) 22A determined from the resistors 13 and 14 thereof and a gain determined from the resistors 17 and 15 of the potential difference detection circuit 23A, which enables the correction of an error in the blur output in the yaw direction YBV due to erroneous electric charge.

Note that the correction value of the blur output in the yaw direction YBV is obtained by the following expression:

Correction value=(potential difference SYV*K)−reference voltage YV (3)

where K is a proportionality coefficient when it is assumed that a certain proportional relation is to be established between the gain of the amplifier circuit (LPF) 22A and the gain of the potential difference detection circuit 23A.

Moreover, the first terminal S2a of the gyro-sensor S2 is connected to the positive side of a condenser C23 for power supply, and the negative side of the condenser 23 is grounded. An electrode of the positive side of the condenser C23 is applied with a predetermined voltage.

The high-pass filter (HPF) 21B includes a condenser C21, resistors R21 and R22, and a selector switch ASW2. The second terminal S2b of the gyro-sensor S2 is connected to one side of the condenser C21. The third terminal S2c of the gyro-sensor S2 is grounded, and the fourth terminal S2d is used for a reference voltage supply terminal.

The other side of the condenser C21 is connected to one side of the resistor R21 and one side of the selector switch ASW2. The other side of the resistor R21 is connected to the pitch direction reference voltage signal line PL which extends from the fourth terminal S2d. The other side of the selector switch ASW2 is connected to the pitch direction reference voltage signal line PL via the resistor R22. The selector switch ASW2 is input with a high-speed charge signal from the processor 104.

Here, the condenser C21 and the resistor R21 constitute a high-pass filter, and the resistor R22 and the selector switch ASW2 constitute a high-speed charge circuit. The resistor R21 is set to have a larger value than the resistor R22. When the selector switch ASW2 is turned on by the high-speed charge signal from the processor 104, the condenser C21 is electrically charged at high speed via the resistor R22.

The amplifier circuit (LPF) 22B includes an operational amplifier OP21, a condenser C22, a resistor R23, and a resistor R24. The output signal of the gyro-sensor S2 is input to the positive terminal of the operational amplifier OP21 via the condenser C21. The negative terminal of the operational amplifier OP21 is connected to the pitch direction reference voltage signal line PL via the resistor R23, and the output terminal thereof is connected to one side of the condenser C22. The other side of the condenser C22 is connected to the negative side of the operational amplifier OP21. The condenser C22 and the resistor R24 constitute a low-pass filter.

The high-pass filter (HPF) 21B removes direct-current components of the output signal of the gyro-sensor S2 in order to prevent a shake of an image while the amplifier circuit (LPF) 22B removes noise signals with the low-pass filter and amplifies output signals to output blur signals in the pitch direction to an ADC/INP2 terminal of the processor 104 in order to improve image quality.

The potential difference detection circuit 23B is composed of operational amplifiers OP22 and OP23 and resistors R25, R26, and R27. The positive terminal of the operational amplifier OP22 is connected to the other side of the condenser C21, the positive terminal of the operational amplifier OP21, one side of the resistor R21, and one side of the resistor R22. The output of the high-pass filter has high impedance at its output so that the operational amplifier OP 22 functions as a buffer circuit for impedance conversion.

The output terminal of the operational amplifier OP22 is connected to the positive terminal of the operational amplifier OP23 via the resistor R26, and connected to the negative terminal of the operational amplifier OP22. The negative terminal of the operational amplifier OP23 is connected to the second terminal S2b of the gyro-sensor S2 via the resistor R25. The output terminal of the operational amplifier OP23 is connected to the negative terminal of the operational amplifier OP23 via the resistor R27. A resistor 28 is connected to the positive terminal of the operational amplifier OP 23 at one side, and connected to the pitch direction reference voltage signal line PL at the other side. A potential difference in the yaw direction is output from the output terminal of the operational amplifier OP23 to the ADC/INP1 terminal of the processor 104.

The resistors R25 and R26 are set to have the same resistance value, and the resistors R27 and R28 are set to have the same resistance value. A potential difference SPV of the high-pass filter from the reference voltage PV is detected at the input terminal of the operational amplifier OP23. From the output terminal of the operational amplifier OP13, output is a potential difference output in the pitch direction β·SPV which has been amplified (β=resistance value of resistor 27/resistance value of resistor 25) times.

Accordingly, it is made possible to find a fluctuation amount of a blur output in the pitch direction PBV due to the potential difference SPV of the high-pass filter by setting a certain relation between a gain of the amplifier circuit (LPF) 22B determined from the resistors 23 and 24 thereof and a gain determined from the resistors 27 and 25 of the potential difference detection circuit 23B, which enables the correction of an error in the blur output in the pitch direction PBV due to erroneous electric charge.

Note that the correction value of the blur output in the pitch direction PBV is obtained by the following expression:

Correction value=(potential difference SPV*H)−reference voltage PV (4)

where K is a proportionality coefficient when it is assumed that a certain proportional relation is to be established between the gain of the amplifier circuit (LPF) 22B and the gain of the potential difference detection circuit 23B.

The processor 104 changes the reference voltages YV, PV of the digital analog converters (DAC) 20A, 20B so that the potential difference in the yaw direction SYV of the high-pass filter and the potential difference in the pitch direction SPV thereof are to be equal to or less than a predetermined allowable value for the potential difference.

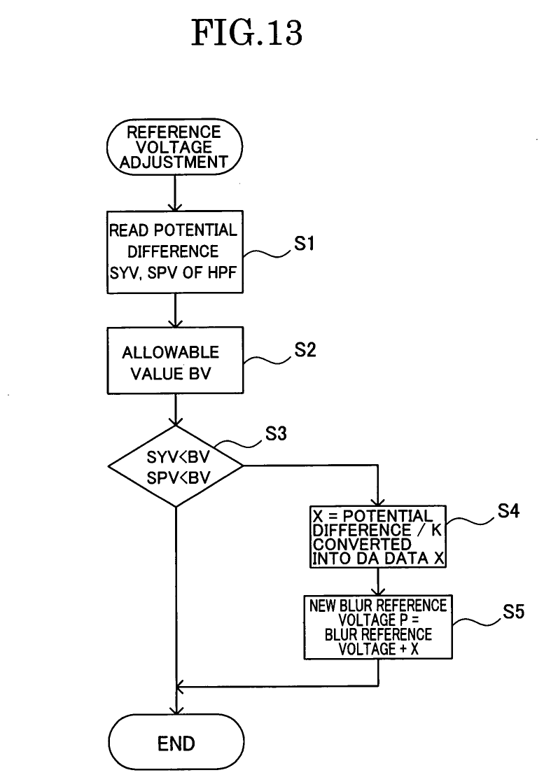

As shown in the flowchart of FIG. 13, the processor 104, when set in a reference voltage operation mode according to manipulation to the release switch SW1, reads the potential differences SYV, SPV of the high-pass filters 21A, 21B from the potential difference output of the potential difference detection circuits 23A, 23B and temporarily stores them (S1). Then, the processor 104 reads the allowable value BV of the potential differences SYV, SPV which is determined in advance depending on the characteristics of the gyro-sensors S1, S2 (S2). Thereafter, the processor 104 determines whether the potential differences SYV, SPV are larger/smaller than the allowable value BV (S3). When the potential difference SYV, SPV are smaller than the allowable value BV, the processor 104 maintains the reference voltages YV, PV obtained in the previous processing.

On the other hand, with the potential difference SYV, SPV being larger than the allowable value BV, it finds digital-analog conversion data X by the following expression (S4):

X=potential difference/K value, where the K value is a voltage conversion coefficient for 1-bit of the AD converter (ADC) and 1-bit of DA converter (DAC).

Then, the processor 104 finds a new blur reference voltage Pᵢ (YV, PV) at exposure by the following expression:

New blur reference voltage Pᵢ=previous blur reference voltage Pᵢ₋₁+X (S5).

The processor 104 finds an amount of fluctuation in the blur output using the new blur reference voltage Pᵢ (YV, PV) at the turning-on of the release switch (exposure).

Thus, the processor 104 repetitively detects the potential difference with a predetermined interval, and finds a new blur reference voltage Pᵢ according to the previous blur reference voltage Pᵢ₋₁. The new blur reference voltage Pᵢ is set to be a blur output inputted from the amplifier circuits 22A, 22B to the ADC/INP2 terminal, and ADC/INY2 terminal of the processor when the camera body is free from blur (when stationary). Then, the amount of fluctuation in the blur output in the yaw direction YBV, PBV during the exposure can be corrected by the expressions (3) and (4) according to a blur output associated with the new blur reference voltage Pᵢ obtained immediately before the exposure. Thus, the processor 104 also functions as the reference voltage correcting section.

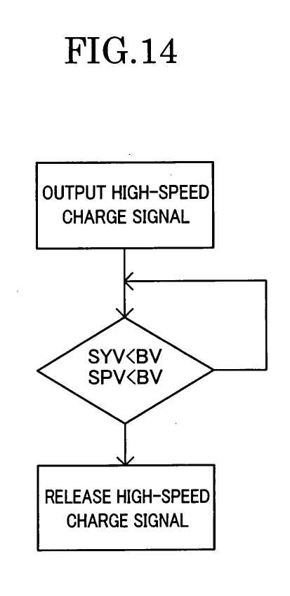

A shake or motion of the camera body such as panning causes potential differences between the second terminals S1b, S2b of the gyro-sensors S1, S2 and the other sides of the condensers to get larger than the allowable value BV (outside the allowable range). When this occurs, the processor 104 outputs the high-speed charge signal to the high-speed charge circuit and continues the output while the potential difference SYV, SPV are larger than the allowable value BV, and releases the high-speed charge signal when the potential differences SYV, SPV get smaller than the allowable value BV, as shown in FIG. 14.

The operation of the high-speed charge circuit in the second embodiment is the same as that in the first embodiment. Also in the second embodiment, it is preferable that the allowable range is changed based on the internal temperature information, as in the first embodiment.

Although the present invention has been described in terms of exemplary embodiments, it is not limited thereto. It should be appreciated that variations may be made in the embodiments described by persons skilled in the art without departing from the scope of the present invention as defined by the following claims.

What is claimed is:

1. An imaging apparatus comprising:
a blur detection section which detects a blur in an image;
a high-pass filter which is connected with the blur detection section;
a potential difference detection section which detects a potential difference between both ends of a passive circuit element constituting the high-pass filter;
a reference voltage adjusting section which adjusts a reference voltage applied to the high-pass filter so that the potential difference detected by the potential difference detection section is to be in a preset allowable range; and
a blur correction section which corrects the blur detected by the blur detection section.

2. An imaging apparatus comprising:
a blur detection section which detects a blur in an image;
a high-pass filter which is connected with the blur detection section;
a potential difference detection section which detects a potential difference between both ends of a passive circuit element constituting the high-pass filter;
a reference voltage correcting section which corrects a reference voltage applied to the high-pass filter by an arithmetic operation in accordance with the potential difference detected by the potential difference detection section; and
a blur correction section which corrects the blur detected by the blur detection section according to a result of the correction by the reference voltage correcting section.

3. An imaging apparatus according to claim 1, wherein:
the passive circuit element is a condenser and includes a high-speed charge circuit which electrically charge the condenser at a high speed; and
when the potential difference between both ends of the condenser falls outside the preset allowable range, the high-speed charge circuit is driven to charge the condenser at a high speed.

4. An imaging apparatus according to claim 2, wherein:
the passive circuit element is a condenser and includes a high-speed charge circuit which electrically charge the condenser at a high speed; and
when the potential difference between both ends of the condenser falls outside the preset allowable range, the high-speed charge circuit is driven to charge the condenser at a high speed.

5. An imaging apparatus according to claim 3, wherein
the reference voltage is adjusted while the condenser is charged at a high speed.

6. An imaging apparatus according to claim 4, wherein
the reference voltage is adjusted while the condenser is charged at a high speed.

7. An imaging apparatus according to claim 1, further comprising
a temperature detection section which detects an internal temperature of a camera body, wherein
the preset allowable range is changed according to internal temperature information of the temperature detection section.

8. An imaging apparatus according to claim 2, further comprising
a temperature detection section which detects an internal temperature of a camera body, wherein,
the preset allowable range is changed according to internal temperature information of the temperature detection section.

9. An imaging apparatus according to claim 1, wherein
a blur output detected by the blur detection section is corrected according to the potential difference between both ends of the high-pass filter and to a predetermined value.

10. An imaging apparatus according to claim 9, further comprising
an amplifier circuit which amplifies the blur output detected by the blur detection section, wherein:
the potential difference detection section includes an amplifier; and
the predetermined value is determined by a gain of the amplifier and a gain of the amplifier circuit.

11. An imaging apparatus according to claim 1, wherein
the potential difference detection section is constituted of a differential amplifier circuit.

12. An imaging apparatus according to claim 2, wherein
the potential difference detection section is constituted of a differential amplifier circuit.

13. An imaging apparatus according to claim 2, wherein
the reference voltage correcting section stores the potential difference detected by the potential difference detection section at a predetermined timing, and corrects an amount of fluctuation of a blur output according to the detected potential difference.

14. An imaging apparatus according to claim 2, wherein
a blur output detected by the blur detection section is corrected according to the potential difference between both ends of the high-pass filter and to a predetermined value.

15. An imaging apparatus according to claim 13, further comprising
an amplifier circuit which amplifies the blur output detected by the blur detection section, wherein:
the potential difference detection section includes an amplifier; and
the predetermined value is determined by a gain of the amplifier and a gain of the amplifier circuit.
